(19) United States
(12) Patent Application Publication
(10) Pub. No.: US 2021/0339343 A1
(43) Pub. Date: Nov. 4, 2021

(54) METHOD FOR DETECTING WELDING DEFECTS IN ARC WELDING AND ARC WELDING SYSTEM

(71) Applicant: GESTAMP SERVICIOS, S.A., Madrid (ES)

(72) Inventor: Jan LODEWIJK KEES, Madrid (ES)

(21) Appl. No.: 17/283,244

(22) PCT Filed: Oct. 7, 2019
(86) PCT No.: PCT/EP2019/077120

§ 371 Date: Apr. 6, 2021

(30) Foreign Application Priority Data
Oct. 8, 2018 (EP) 18382709.6

(51) Int. Cl. B23K 31/12; B23K 9/095; G01N 25/72

(52) U.S. Cl. CPC B23K 31/125; B23K 2103/04; G01N 25/72; B23K 9/0956

(57) ABSTRACT

A method for detecting defects in arc welding is disclosed. The method comprises measuring an average weld pool temperature of a weld using an infrared sensor while welding, the infrared sensor being arranged with the weld torch. The method further comprises determining a defective condition of the weld based at least on the measured weld pool temperature. Weld systems suitable for carrying out such methods are also provided.

The present application claims the benefit of European patent application no EP18382709.6 filed on Oct. 8, 2018.

The present disclosure relates to quality control in welding processes, and more particularly relates to methods for detecting defects in arc welding. The present disclosure further relates to welding systems.

### BACKGROUND

It is widely known to join workpieces by means of welding methods. In some technical fields such as automotive or aircraft industries quality control of welds is extremely important in order to meet the requirements of safety specifications.

Quality controls of the welds may be carried out in different ways. A simple method may be based on visual inspection by an operator. However, that method requires a proper training of the personnel and is both time consuming and prone to suffer from human errors.

Some other quality controls of welds may be based on inspecting the weld seam by means of destructive testing such as tensile strength test, nick break test, back bend test, or the like. Other methods are based on non-destructive testing such as remote visual inspection, X-rays, ultrasonic testing and liquid penetration testing. In all cases, the known methods are time consuming and require significant material and human resources.

CN107931802A discloses a method for welding seam quality detection of electric-arc welding. The method is characterized in that an infrared camera is adopted for photographing a high-temperature welding seam area 10 mm behind a formed welding pool during welding to form a real-time welding infrared image; the infrared image is converted into digital information through a temperature calibration method, and extraction and calculation are performed according to acquired data to obtain width and a center track line of a weld seam; and welding defects are judged according to changes of the width and the center track line of the welding seam.

One aspect of this method is that an IR camera is placed fixedly and therefore it cannot provide a proper response to a change in the trajectory of the torch.

U.S. Pat. No. 4,594,497 discloses an image processing welding control method comprising detection of an isothermal pattern of a weld zone in the welding state through photographing the weld zone by an infrared camera.

CN 107 081 503 discloses an infrared non-destructive testing method for real-time detection of welding defects. The infrared detector detects the radiation intensity and displays a digital image.

Both these prior art documents employ a digital camera providing a pixelated temperature distribution. From an analysis of the distribution of temperatures certain aspects of welds may be derived.

CN106216814 discloses an arc welding robot which comprises a signal detecting and collecting device. The signal detecting and collecting device comprises a laser sensor and an infrared sensor. The laser sensor performs a seam tracking and the infrared sensor is used for measuring the weld seam temperature, i.e. both sensors measure the glowzone.

One aspect of this configuration is the relatively high complexity and a relatively poor flexibility since the temperature measurement is dependent on the paths or angles adopted by the robot when a welding operation is carried out.

EP 0 092 753 discloses the use of an infrared sensor and preferably an array of infrared sensors provided with spectral filtering means for observation of the arc region during electric arc welding operation. The filter suppresses almost all of the infrared radiation produced by the arc itself by filtering out all IR radiation having a wavelength up to three microns. Linear temperature profiles may be obtained to e.g. determine puddle dimensions.

The present disclosure provides examples of methods and systems that at least partially resolve some of the aforementioned disadvantages.

### SUMMARY

In a first aspect, a method for detecting defects in arc welding is provided. The method comprises measuring an average weld pool temperature of a weld using an infrared sensor while welding, the infrared sensor being arranged with a weld torch. And the method further comprises determining a defective condition of the weld based at least on the measured weld pool temperature.

According to this aspect, the method for detecting defects may rely on the temperature measurement of the weld pool using an infrared sensor. An infrared sensor, as opposed to an infrared camera, gives a unique value for every measurement (rather than a collection of measurements for each pixel in the case of an infrared camera). Data processing of singular values can be quicker and simpler. Because the infrared sensor is directly arranged with the torch and aims at the weld pool, the measurement may be performed regardless of the weld width and the trajectory line of the weld. The sensor will follow the path of the torch invariably.

Using the infrared sensor, the weld pool temperature may be measured in a single measuring spot, the measuring spot substantially encompassing the weld pool. The weld pool temperature may therefore be considered an average weld pool temperature, as opposed to a temperature in one specific point of the weld pool.

The method according to the first aspect provides a more flexible and simpler configuration than the known solutions. The method may be put into practice in welding operations where the weld paths and torch trajectories are either repetitive or changing.

Furthermore, the method provides a solution for detecting defects in arc welding which is not prone to suffer from human errors and does not require significant material and human resources as some of the prior art solutions. The operator may be involved only when a defective weld is detected so they do not need to spend their time inspecting all the resulting welds.

The method may be implemented regardless of the range of working temperatures, so it does not depend on the materials of the workpieces to be welded. The method according to the first aspect may be implemented for welding workpieces which may be static or moved with respect to the torch.

The measurement may be performed in real-time, i.e. simultaneously with the welding. The measurements may be made substantially continuously, i.e. at a frequency that is high enough so that measurements may give information on defects. A suitable frequency for the measurements may be e.g. 10 Hz-1 kHz, and specifically 50-100 Hz.

In a further aspect, a welding system is provided. The welding system comprises an arc welding torch, an infrared sensor arranged with the torch in such a way that the infrared sensor is focused on the weld pool. The weld system further comprises a controller in data communication with the IR sensor, and the welding system is configured to perform a method for detecting welding defects according to any one of the herein disclosed examples.

### BRIEF DESCRIPTION OF THE DRAWINGS

Non-limiting examples of the present disclosure will be described in the following, with reference to the appended drawings, in which:

FIG. 1 schematically illustrates a welding system according to an example;

FIG. 2 schematically illustrates a longitudinal section view of the torch and the IR sensor of the system of FIG. 1 in an example of welding operation;

FIG. 3 schematically illustrates an IR sensor of the FIG. 1 with a lens to adjust the spot size thereof;

FIG. 4 shows a flow diagram representing a method for detecting defects in arc welding according to one example;

FIG. 5A is a graph illustrating the weld pool temperature over time related to an example of a weld without remarkable defects;

FIG. 5B is an image of a weld related to the graph of FIG. 5A;

FIG. 6A is a graph illustrating the weld pool temperature over time related to an example of a weld with burn through defect;

FIG. 6B is an image of a weld related to the graph of FIG. 6A;

FIG. 7A is a graph illustrating the weld pool temperature over time related to an example of a weld with a misalignment defect;

FIG. 7B is an image of a weld related to the graph of FIG. 7A;

FIG. 8A is a graph illustrating the weld pool temperature over time related to an example of a weld with a misalignment defect in a lap joint;

FIG. 8B is an image of a weld related to the graph of FIG. 8A;

FIG. 9A is a graph illustrating the weld pool temperature over time related to an example of a weld with a gap defect in a T-joint;

FIG. 9B is an image of a weld related to the graph of FIG. 9A;

FIG. 10A is a graph illustrating the weld pool temperature over time related to an example of a weld with a gap defect in a butt joint;

FIG. 10B is an image of a weld related to the graph of FIG. 10A;

FIG. 11A is a graph illustrating the weld pool temperature over time related to an example of a weld with a weld feed disruption defect;

FIG. 11B is an image of a weld related to the graph of FIG. 11A;

FIG. 12A is a graph illustrating the weld pool temperature over time related to an example of a weld with a porosity defect;

FIG. 12B is an image of a weld related to the graph of FIG. 12A;

FIG. 13A is a graph illustrating the weld pool temperature over time related to a weld with an unstable weld defect;

FIG. 13B is an image of a weld related to the graph of FIG. 13A; and

FIG. 14 schematically illustrates a comparison of a temperature profile with an expected temperature profile.

### DETAILED DESCRIPTION OF EXAMPLES

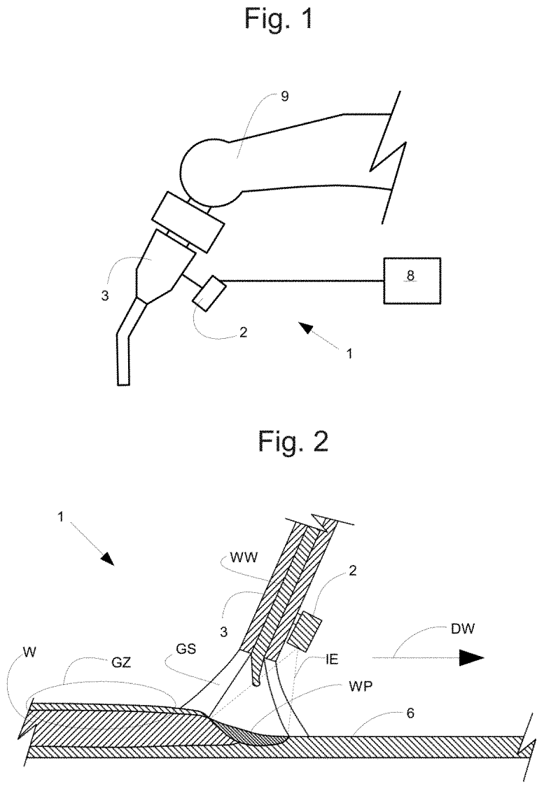

FIG. 1 schematically illustrates a welding system 1 according to an example. The welding system 1 may comprise a robot arm 9 to carry the torch 3 and the infrared (IR) sensor 2.

FIG. 2 schematically illustrates a longitudinal cross-sectional view of the torch and the IR sensor 2 of the system of FIG. 1 in an example of welding operation.

According to an aspect, the welding system 1 comprises: an arc welding torch 3. The torch 3 carries an electrode through which current passes. Arc welding is a process that is used to join metal to metal by using electricity to create enough heat to melt metal, and the melted metals when cool result in a binding of the metals. An electric arc between an electrode and the base material is used to melt the metals at the welding point.

In use, a weld pool WP in workpieces 6 to be welded is created. The weld pool may be defined as the workable portion of a weld where the base metal has reached its melting point.

An IR sensor 2 is shown arranged with torch 3. As shown in this example, the IR sensor may be directly mounted on the torch, i.e. the torch 3 carries the IR sensor 2 as it moves. The IR sensor 2 is positioned and directed with respect to the torch in such a way that the IR sensor 2 is focused on the weld pool WP.

The IR sensor 2 may have a measurement spot 7 which may encompass the weld pool WP. The weld system according to this example, further includes a controller 8 in data communication with the IR sensor 2.

In some examples, the controller 8 may be placed in a welding cell (not illustrated) along with the IR sensor 2 and the torch 3 or it may be remotely placed. The controller may be integrated in e.g. a robot arm carrying the welding torch. It may also be a stand-alone system in wired or wireless connection with the weld torch and IR sensor.

As can be seen in FIG. 2 the IR sensor 2 may be focused on the weld pool WP. The glowzone GZ can be seen behind the torch 3 considering the direction of welding DW.

In order to carry out the arc welding, a wire WW may be fed through the torch 3 as will be apparent to those skilled in the art. A shield gas GS or protective gas may also be used so as to protect the weld area from oxygen and/or water vapor.

In some examples, the IR sensor may be a CT 1M infrared noncontact sensor and be able to perform a temperature measurement in the range of 650-1000° C. and using a wavelength of 1 μm. In other examples, the IR sensor may be a 2M sensor able to perform a temperature measurement in the range of 385-1600° C. at a wavelength of 1.6 μm. Such sensors may be used particularly for measurements when welding steel.

In alternative examples, the IR sensor may be a 3M sensor configured to perform a temperature measurement in the range of 150-600° C. at a wavelength of 2.3 μm. This example of IR sensor may be suitable for aluminum workpieces. Other suitable IR sensors may also be used.

It has been found that the measurements are most sensitive (and thus potentially can provide the best results) in the wavelength range below 4 microns, and more particularly below 3 microns. Even though at such wavelength ranges radiation from the torch is also measured, it has been found that the obtained temperature profiles are very reliable for indicating weld defects.

In further examples, the system 1 may comprise a protective case in which an IR sensor may be fixed. The protective casing may be made from heat resistant material such as aluminum. A shielding layer of ceramic material may be used to protect the IR sensor 2 from the welding back spatter. The shielding layer can withstand significantly high temperatures and may be hard enough to cause the back spatter to bounce off. An UV-filtering piece may be used to protect the IR sensor 2 from UV rays that may come from the arc of the welding operation. Electric or data cables arranged with the sensor might be provided with a protective shield, e.g. a mesh cover in order to avoid such cables from melting or being damaged by sputter from the weld pool. In some examples, braided stainless steel covers may be used.

In some examples the torch 3 and the IR sensor 2 may be carried by a robot arm 9. The robot arm 9 may be actuated on by multiple actuators controlled by the controller 8. The IR sensor 2 may be associated with the torch 3 in such a way that when the torch 3 is moved by the robot arm 9 the IR sensor 2 is moved as well. This may enhance the flexibility of the system 1 to perform the method for detecting welding defects since it may be independent from the path and the angle followed by the torch 3.

The system 1 may further comprise a nozzle and a high pressure source to channel fluid e.g. air towards the sensor in order to clean it. Alternatively or additionally, a mechanical brush, e.g. a steel brush may be used to clean the sensors. In one example, mechanical brushes may be fixedly arranged, and the torch with sensor may be moved towards the brushes and along the brushes for cleaning. The frequency of cleaning may be determined in accordance with circumstances. In one example, the sensor may be cleaned after all welds in one component have been performed. After the welds have been carried out, a component may be moved to a stillage or to another workstation. The next component will then arrive. The time between a first component being moved away and the next component arriving may be used for e.g. cleaning of the sensor and weld torch.

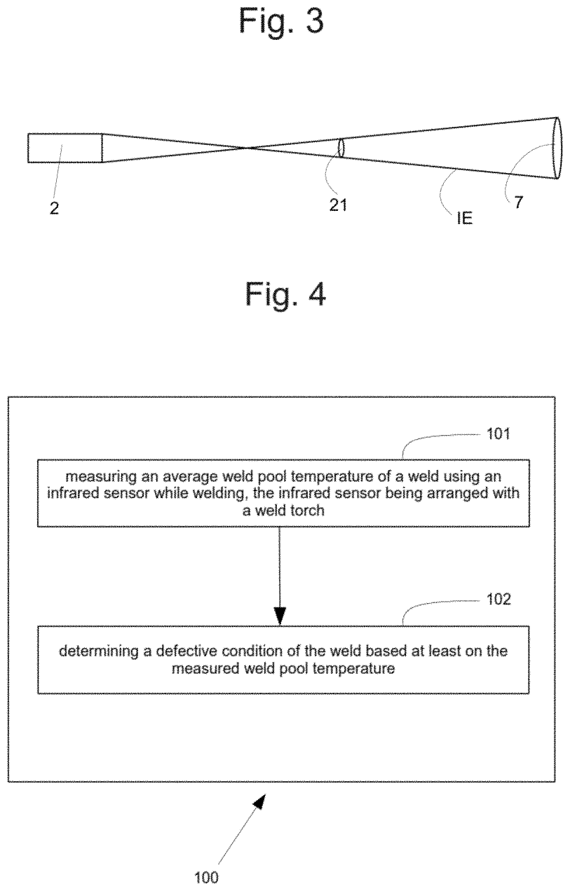

FIG. 3 schematically illustrates the IR sensor 2 of FIG. 1 with a lens 21 to adjust the spot 7 size thereof. In the example of FIG. 3, the IR sensor 2 may comprise an operable lens 21 configured to adjust the spot 7 size of the IR sensor 2. This way, the user may adjust the area from which the infrared energy IE may be received and measured by the IR sensor 2. Therefore, the size of the spot 7 may be changed based on the size (width) of the weld pool WP. By way of example, the spot size may be between 10-15 mm, and specifically about 13.5-14 mm.

In some examples, the IR sensor 2 may be configured to measure an average temperature of the weld pool WP. In every measurement, the temperature measured will be a result of the temperature throughout the spot (the measurement area). The spot 7 may be sized to so as to substantially encompass the weld pool WP. In some particular examples, the spot 7 may be substantially circular and have a diameter substantially similar to the width of the weld pool WP.

In some alternative examples, the size of the spot 7 may be chosen such that the spot 7 may be substantially larger than the width of the weld pool WP. The latter may be useful in order to detect a fuse through defect.

FIG. 4 shows a flow diagram representing a method 100 for detecting defects in arc welding according to one example.

According to a further aspect, the method 100 for detecting defects in arc welding comprises measuring 101 weld pool temperature of a weld W at different points in time using the IR sensor 2 while welding and determining 102 a defective condition of the weld W based at least on the measured weld pool temperature. Each point in time may refer to a different timestamp.

In particular, the weld pool temperature may be measured substantially continuously. In some examples, the weld pool temperature may be measured every 10 ms.

In some examples, determining a defective condition may comprise verifying a deviation from an expected temperature profile. A temperature profile may indicate temperature over time, or temperature as a function of a position. Such a deviation may be a sudden jump or drop in temperature, or a more gradual rise or decrease in temperature when a substantially constant temperature is to be expected. In particular, if a temperature measurement falls outside an expected bandwidth, a defective condition may be registered.

The comparison with an expected temperature profile may comprise fitting a measurement timestamp with a corresponding point in time for the expected temperature profile. The time fitting may be based on a starting point or end point of the temperature profiles or may be based on one or more characteristic features of the temperature profiles.

Alternatively, fitting an obtained temperature time profile over an expected temperature profile may be based on positions of the measurements.

A bandwidth may be defined about an average temperature profile. The average temperature profile may be determined from a plurality of measured welds (e.g. 100 welds or more) that have no defects. The bandwidth may be defined e.g. by a plurality of standard deviations of the temperature measurement. The upper band, lower band, and bandwidth may be determined by choosing probability levels and determining the probability of temperature deviations with respect to the average (or expected) temperature profile. E.g. a Gaussian probability distribution may be used.

In some examples, an expected temperature profile, and a standard bandwidth may be defined from a plurality of welds without defects. The expected temperature profile and standard bandwidth may be used for comparable welds. If a different weld employing one or more welding parameters different from the reference welds is to be monitored, an adapted increased bandwidth may be used.

It has been found that similar weld faults lead to similar variations in temperature profiles regardless of e.g. different materials used. I.e. the absolute values of temperature measurements for different materials may be different, but the detection of weld faults may be particularly based on the variation of the temperature rather than an absolute value of the temperature.

A weld defect detected or identified using the IR sensor and the methods presented herein may be related to at least one of the following: burn through, porosity, misalignment of the weld, fuse through, unstable welds, deviation of gap between workpieces to be joined or a combination thereof.

In some examples, the method may comprise computing a temperature difference between two different points in time, wherein determining a defective condition may further comprise verifying whether the temperature difference satisfies a difference threshold. The controller 8 may calculate the weld pool temperature difference between at least two different measurements. By way of example, if the computed temperature difference is less than the difference threshold the defective condition is negative so the weld may be labeled as not defective. However, if the computed temperature difference is greater than or equal to the difference threshold, the defective condition is positive so the weld W may be labeled as defective.

According to a further example, classifying a defect may comprise verifying whether the temperature difference occurs within a predetermined interval. If a temperature difference is greater than or equal to a difference threshold then a defective condition may be positive as above mentioned. If the temperature difference happens faster than a predefined interval then a classification of burn through may be assigned to the weld W.

Alternatively, the sample data may be analyzed seeking a slope (i.e. rate of change) whose absolute value may be greater than or equal to a slope threshold. If the absolute value of the slope is greater than or equal to a slope threshold a classification of burn through may be assigned to the weld W.

In some examples, determining a defective condition may further comprise seeking or identifying an oscillation in measured weld pool temperature and verifying whether the amplitude of the oscillation satisfies an amplitude threshold. By way of example, if the amplitude is less than the amplitude threshold the defective condition is negative so the weld may be labeled as not defective. However, if the amplitude is greater than or equal to the amplitude threshold, the defective condition is positive so the weld W may be labeled as defective.

According to a further example, classifying a defect may comprise assigning to the weld a porosity defect when the amplitude of an oscillation is greater than or equal to an amplitude threshold.

In some examples, the method 100 may further comprise producing sample data derived from the measured weld pool temperature and correlated points in time; wherein determining a defective condition may further comprise determining whether the sample data satisfies a predefined data pattern. By way of example, if the sample data substantially matches a predefined data pattern of a defective condition, the same defect may be detected for the sample data A database may be available to the controller 8 so as to store a number of predefined data patterns. Predefined data patterns may be related to defective conditions or to welds without defects.

In some further examples, correlated quality control data of a performed welding may be used as a feedback so as to update and enlarge the database. I.e. if a defect is found in a quality control, the data of the temperature measurements may be uploaded to the database and linked to the defect found in the quality control.

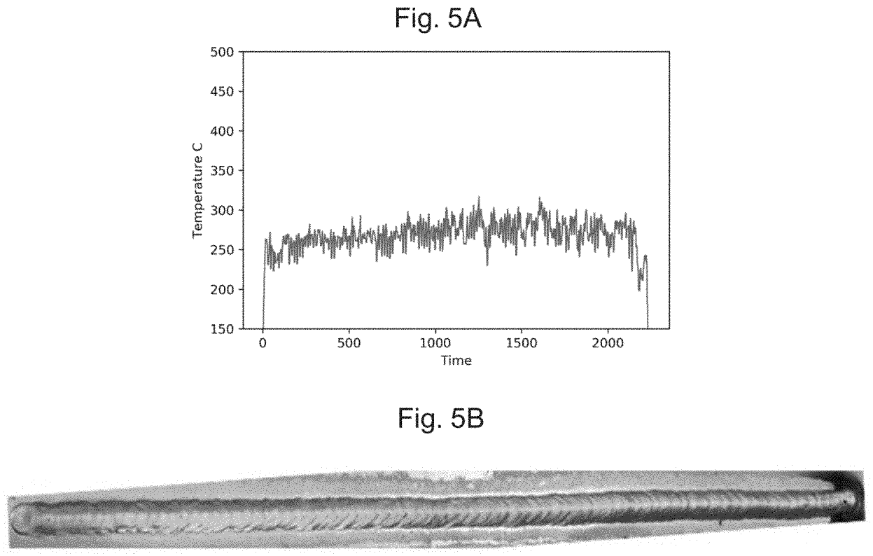

In alternative examples, the method 100 may further comprise generating a graph for measured temperature versus time; wherein determining a defective condition may further comprise determining whether at least a portion of the shape of the generated graph satisfies a predefined graph pattern. The graph may be an example of sample data derived from the measured weld pool temperature with correlated points in time. Graphs may be visualized on a screen. Some examples of graphs can be seen in FIGS. 5A-13A.

In some examples, the method 100 may further comprise generating an anomaly signal when a defective condition is positively determined.

In some examples, the method 100 may further comprise stopping a welding operation of work pieces 6 when the anomaly signal is generated. Depending on the defect, the controller 8 may generate a command to stop the torch 3 and a warning signal to an operator.

In some examples, the method 100 may further comprise adjusting a spot 7 size of the IR sensor 2 so as to enclose the width of the weld pool WP.

In some examples, the arc welding may be applied to at least one of the following joints: a butt joint, a lap joint, a T-joint or a combination thereof. In some examples, the arc welding may be applied to one of the aforementioned joints. The data patterns or graphs related to defective conditions may further be classified to the different type of joints.

In some examples, the arc welding may be applied to workpieces 6 made from at least one of steel, aluminum or their alloys. In the attached figures, particularly 5A-13B, some cases belong to welds performed on steel or aluminum and because of that some range of temperatures may be higher than others. However, the present methods 100 and systems 1 may be implemented regardless of the range or absolute values of temperatures. In particular, the temperature variation is more important than the absolute values.

In some examples, when a defective condition is positively determined a welded joint might be reworked if necessary.

In some examples, the method 100 may be performed using at least one of the following approaches: machine learning, data mining, artificial intelligence or a combination thereof.

All of those approaches may be fed with new sample data when they become available after performing welding operations. The data may be assigned to a defect or to “no defect” after a quality control which may include a visual inspection, non-destructive or destructive testing.

Some experiments were carried out to obtain the weld pool temperature over the time while the weld operation is performed. The experiments were carried out by implementing the herein disclosed methods and systems. The sample data of those examples may be used to train for instance a machine learning algorithm.

FIG. 5A is a graph illustrating the weld pool temperature over time related to an exemplary weld without remarkable defects. FIG. 5B is an image of an exemplary weld related to the graph of FIG. 5A. Even though temperature oscillations are shown, these are all due to the equipment used and the inevitable variability in measuring. All values fall within the expected band width arranged round the expected temperature profile.

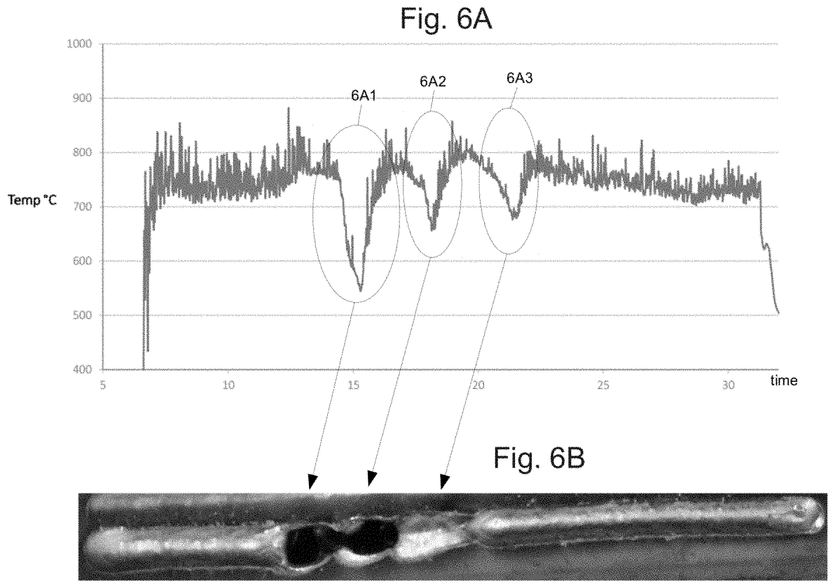

FIG. 6A is a graph illustrating the weld pool temperature over time related to an example of a weld with a burn through defect. FIG. 6B is an image of a weld related to the graph of FIG. 6A. The example illustrated in FIGS. 6A, 6B relates to a weld with burn through defects. In the graph there are three drops in temperature over time that may correlate with burn through because the difference in temperature between the highest temperature and the lowest temperature value along the drop may be greater than a difference threshold. Furthermore, the drop in temperature may occur faster than a predefined interval. In particular, an absolute value of a temperature gradient is particularly high.

Three regions 6A1, 6A2, 6A3 corresponding to those drops have been marked in the graph of FIG. 6A. The drops in temperature may resemble a kind of valleys that comprises a first portion with a decreasing (negative) slope of the graphed line and a second portion with an increasing (positive) slope. The drops in temperature may be caused by to a portion of the workpieces 6 being melted completely by the built-up heat. Some arrows link the regions 6A1, 6A2, 6A3 to an area of the image where the burn through phenomena can be seen. As the material is completely melted away, the temperature measurement of the IR sensor drops rapidly, as air underneath the pieces to be welded is included in the measurement. After the burn through, the temperature returns to normal, expected, values.

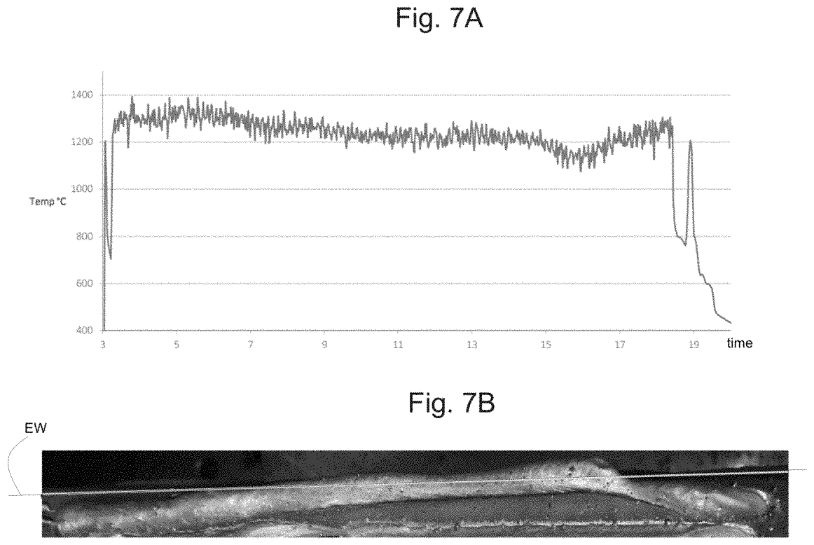

FIG. 7A is a graph illustrating the weld pool temperature over time related to an example of a weld with a misalignment defect. FIG. 7B is an image of an exemplary weld related to the graph of FIG. 7A. In this example, the misaligned weld was produced by welding beyond an edge of workpieces EW. In the plot, the temperature can be seen to drop steadily as it approaches the edge of the workpiece EW. The temperature drop may be caused by a change in the surface geometry where the welding is performed. If the welding goes beyond the edge of workpiece EW the surface geometry may change. A change in surface geometry may change the heat dissipation and thereby also the measured temperature.

Both in the case of misalignment and burn through, the temperature variation over time is indicative of the presence of a weld defect. Clearly however, the temperature gradients are different for a misalignment and for a burn through. With the system as herein described, a weld defect may not only be recognized (e.g. by a measured temperature falling outside the expected band width), but also classified. Rework instructions may be generated as a result of this classification.

By way of example, a band width related to a welding without remarkable defects may fall within X1 times the standard deviation of the expected band width; a band width related to a misalignment may fall within X2 times the standard deviation of the expected band width and a band width related to a burn through may fall within X3 times the standard deviation of the expected band width. X1 may be the lowest value, X2 may be higher than X1 and lower than X3, and X3 may be the highest value.

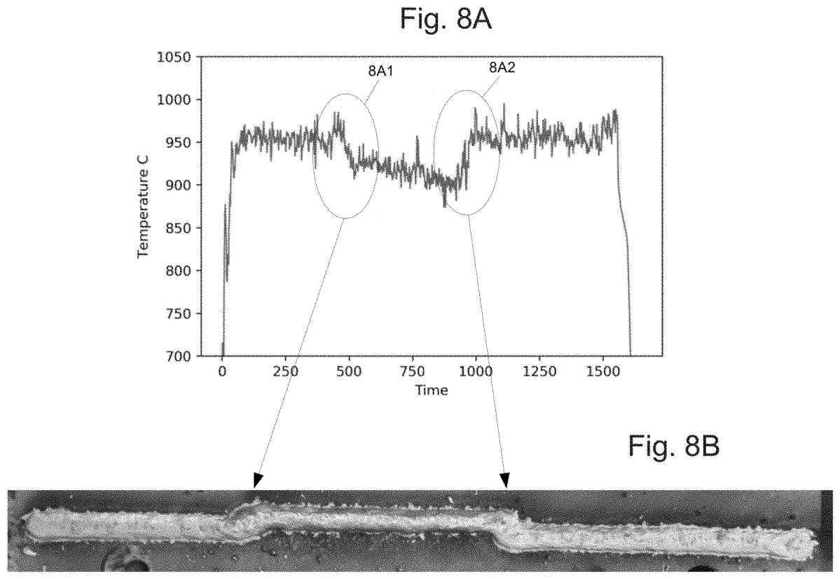

FIG. 8A is a graph illustrating the weld pool temperature over time related to an exemplary weld with misalignment defect in a lap joint. FIG. 8B is an image of an exemplary weld related to the graph of FIG. 8A. The misalignment is caused by moving the tip of the torch off from the expected path.

From time 0 to 400 the tip of the torch may follow an expected path. From time 400 to 1050 the tip of the torch is moved away and the temperature drops. From time 1050 the tip of the torch may move back to the expected path and thus temperature increases and returns to normal values. A temperature drop is highlighted in region 8A1 and a temperature rise is highlighted in region 8A2. The temperature drop may again be caused by a change in surface geometry where the welding is performed. The change in surface geometry changes the heat dissipation and the measured average temperature.

The measured temperature changes are more drastic in FIG. 8 than in FIG. 7, but as may be seen from the accompanying photo, this may be explained by the more sudden misalignment in the case of FIG. 8.

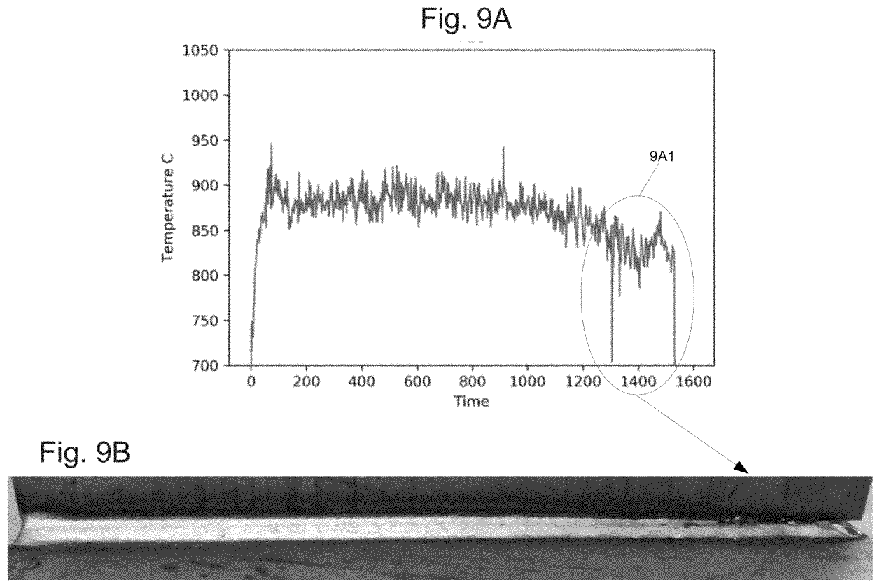

FIG. 9A is a graph illustrating the weld pool temperature over time related to an example of a weld with a gap defect in a T-joint. FIG. 9B is an image of a weld related to the graph of FIG. 9A.

The example illustrated in FIGS. 9A, 9B relates to a weld performed in a T-joint with a gap of about 2 mm at one end and substantially no gap at the other end of the T-joint. The gap was caused between two workpieces to be joined. In FIG. 9B the end of the T joint with gap corresponds to the right side of the figure.

As can be seen in FIG. 9A temperature may steadily drop as the gap may become wider which in this example occurs at about ⅔ distance. The gap at ⅔ distance in this particular example was roughly 1.35 mm. When the weld approaches the end with gap the temperature falls as can be seen in region 9A1. The increasing gap may cause a poor penetration of the weld seam. Thanks to the herein disclosed methods and systems the moment when the weld penetration starts to deteriorate can be detected, for instance when the weld reaches ⅔ distance. About at time 1500 a small slope back up can be seen which was caused by a tack weld. The change in surface geometry may change the heat dissipation and so the temperature does. A deviation in the gap during welding may be thus detected.

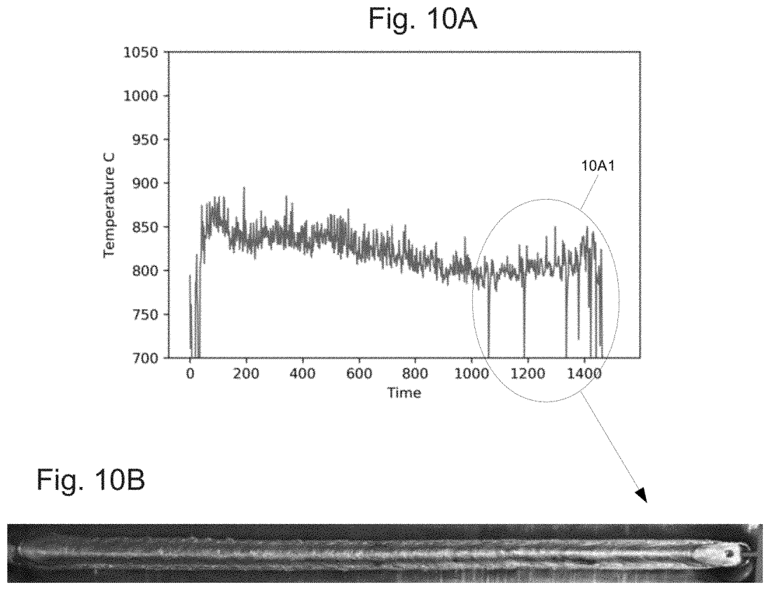

FIG. 10A is a graph illustrating the weld pool temperature over time related to an example of a weld with a gap defect in a butt joint. FIG. 10B is an image of an exemplary weld related to the graph of FIG. 10A. The example illustrated in FIGS. 10A, 10B relates to a weld performed in a butt joint with an increasing gap from one end of the joint where the gap is negligible to the other end where the gap was about 3 mm.

The end with the widest gap is on the right side of FIG. 10B. The weld remains relatively stable until roughly halfway where the temperature starts to decline. That is to say, the temperature starts to decline when the gap becomes wider. Towards the end of the weld, see region 10A1, some spikes can be seen which indicate that some burn troughs occurred. A deviation in the gap during welding may thus be detected.

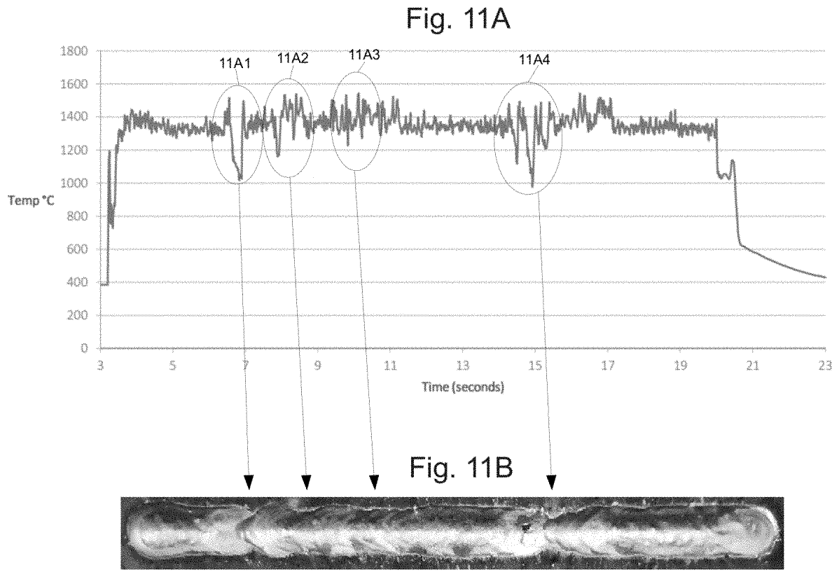

FIG. 11A is a graph illustrating the weld pool temperature over time related to an example of a weld with a weld feed disruption defect. FIG. 11B is an image of a weld related to the graph of FIG. 11A. The wire WW feed was disrupted briefly and multiple times. As can be seen from the plot, particularly regions 11A1-A4, the erratic temperature changes align nicely with the thinning of the weld in the image of FIG. 11B. The larger the spike the thinner the weld may be.

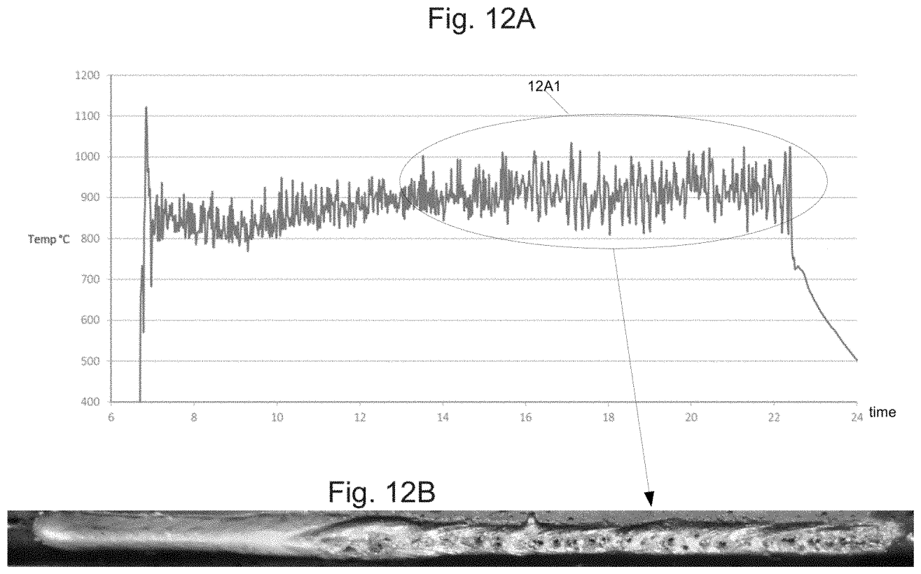

FIG. 12A is a graph illustrating the weld pool temperature over time related to a weld with a porosity defect. FIG. 12B is an image of a weld related to the graph of FIG. 12A. To force porosity and measure its effects on the temperature measurements, the shield gas GS was switched off about midway through the weld. Observing the plot, it can be seen that the amplitude of the weld pool temperature increases as the weld quality deteriorates and the porosity increases. The region 12A1 may correspond to portion of the weld with porosity.

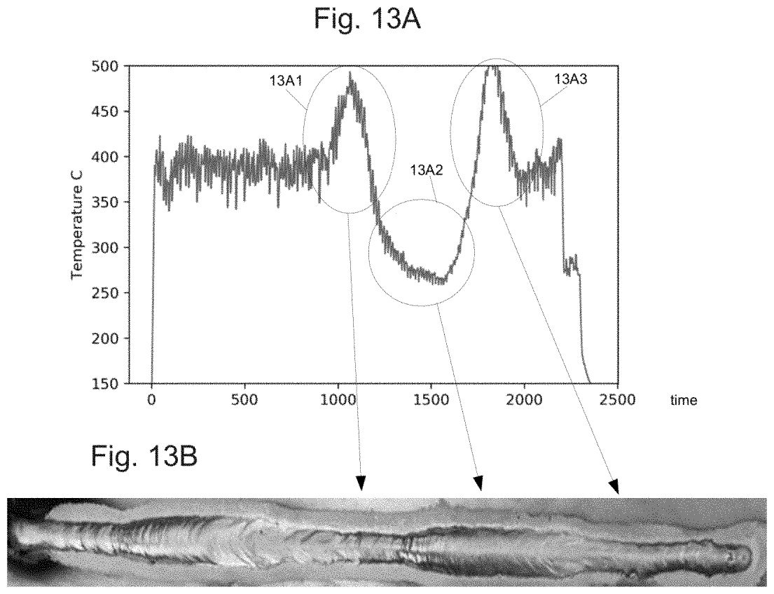

FIG. 13A is a graph illustrating the weld pool temperature over time related to a weld with an unstable weld defect. An unstable weld defect or “weld instability defect” means that the distance of the torch varies with respect to the workpieces to be joined. FIG. 13B is an image of an exemplary weld related to the graph of FIG. 13A.

The unstable weld defect was produced by increasing and decreasing the relative distance between the torch 3 and the workpieces 6 to be joined. The variation in distance was a few centimeters to simulate an unstable weld. Regions 13A1, 13A3 correspond to a decreasing in distance of the tip of the torch and region 13A2 corresponds to an increasing in distance. A decreasing distance may be seen to correspond to a higher weld temperature and an increasing distance may be seen to corresponds to lower weld temperatures.

As mentioned before, machine learning, data mining, artificial intelligence or a combination thereof may be used to improve the detection of weld defects by identifying patterns. Predefined graph pattern may comprise, for instance, those examples of FIGS. 5A to 13A. The predefined pattern may comprise at least one defect related to a defective condition. Then, it may be determined which defect can be related to the generated graph if the defective condition has been determined.

In the examples where machine learning or similar approaches are implemented, these approaches may be fed with the feedback of the quality control data related to performed welds. Thus, the feedback can be used to enhance the output of the approaches. By way of example, the quality control data may comprise the sample data which have been suitably labeled by correlating the sample data to a particular defect or even a non-defective condition. This way, the database may have more patterns to be compared with and the machine learning or any similar approach can produce a more accurate output. The samples may also be classified according to the type of weld, the material of the work pieces. In even further examples, further classification of the weld patterns may be based on weld parameters such as type of electrode, weld speed and others.

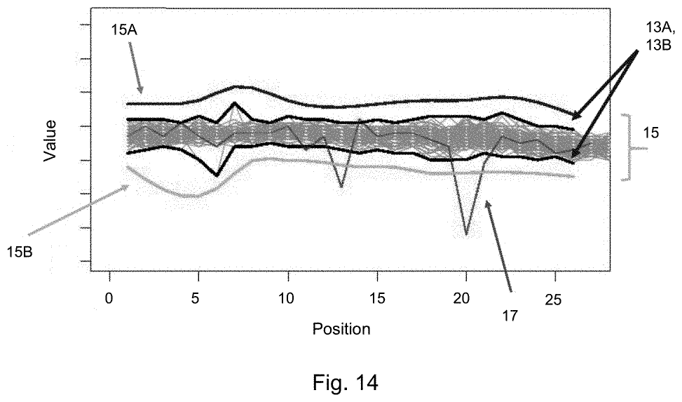

FIG. 14 schematically illustrates a comparison of a temperature profile with an expected temperature profile. In this particular example, the temperature profile indicates temperature as a function of the position along the weld, but it should be clear from the previous examples that temperature profiles indicating temperature over time can be used as well.

Prior to the weld that is to be monitored, multiple welds without defects may have been carried out and the corresponding temperature profiles may have been saved. From the prior measurements, an average or mean temperature profile may be determined, and around this temperature profile a bandwidth may be established.

In this example, the bandwidth is defined by an upper band 13A and a lower band 13B. The upper and lower bands 13A and 13B may be determined such that the probability of a weld without defects falling outside these bands is below a predetermined probability level.

For welds that may not be considered standard (i.e. strictly comparable to the expected temperature profile), an increased bandwidth 15 may be established with upper band 15A and lower band 15B. The increased bandwidth may be determined by multiplying the normal bandwidth 13 by a certain multiplication factor.

If a measured weld temperature 17 goes beyond the (increased) bandwidth, a defect may be determined. In the particular example, this occurs around position 20. Further classification of the type of defects may be based e.g. on a comparison with profiles indicating specific defects, and/or an analysis of the variation of the temperature.

In some examples, the method 100 may be implemented through a welding system 1 as herein disclosed examples. In some alternative examples, the method 100 may be implemented through a welding system 1 wherein the controller 8 may be remotely placed from the IR sensor 2 and the torch 3.

In some examples, the method 100 may be carried out as a part of a quality system or method for monitoring a manufacturing process of a component. The output of the method 100 may be used as parameters indicative of a quality of the weld W and the joined workpieces 6.

Appropriate alarms or rework actions may be triggered automatically when a weld defect is detected and optionally classified.

The controller 8 of the system may be configured as a computer or the like that may comprise suitable hardware, software and/or firmware to carry out the hereinbefore described methods. In another aspect, a computer program product is disclosed. The computer program product may comprise program instructions for causing a computing system to perform any of the methods herein disclosed for detecting defects in arc welding.

Such a computer program product may be embodied on a storage medium (for example, a CD-ROM, a DVD, a USB drive, on a computer memory or on a read-only memory) or carried on a carrier signal (for example, on an electrical or optical carrier signal).

The computer program may be in the form of source code, object code, a code intermediate source and object code such as in partially compiled form, or in any other form suitable for use in the implementation of the processes. The carrier may be any entity or device capable of carrying the computer program.

For example, the carrier may comprise a storage medium, such as a ROM, for example a CD ROM or a semiconductor ROM, or a magnetic recording medium, for example a hard disk. Further, the carrier may be a transmissible carrier such as an electrical or optical signal, which may be conveyed via electrical or optical cable or by radio or other means.

When the computer program is embodied in a signal that may be conveyed directly by a cable or other device or means, the carrier may be constituted by such cable or other device or means.

Alternatively, the carrier may be an integrated circuit in which the computer program is embedded, the integrated circuit being adapted for performing, or for use in the performance of, the relevant methods.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow. If reference signs related to drawings are placed in parentheses in a claim, they are solely for attempting to increase the intelligibility of the claim, and shall not be construed as limiting the scope of the claim.

1. A method for detecting defects in arc welding, comprising:
measuring, while welding, an average weld pool temperature of a weld using an infrared sensor by measuring in a single measuring spot, the measuring spot substantially enclosing a weld pool, the infrared sensor being arranged with a weld torch;
determining a defective condition of the weld based at least on the measured weld pool temperature by verifying whether a measured weld pool temperature deviates from an expected temperature profile.

2. The method according to claim 1, wherein the expected temperature profile is determined as an average temperature profile from a plurality of measured welds that have no defects.

3. The method according to claim 2, wherein no deviation from the expected temperature profile is determined if a measured temperature stays within a bandwidth defined about the expected temperature profile.

4. The method according to claim 1, further comprising:
computing a temperature gradient between two different points in time;
and determining a defective condition if the temperature gradient is above a predetermined temperature gradient threshold.

4. (canceled)

5. The method according to claim 1, wherein determining a defective condition further comprises identifying an oscillation in measured weld pool temperature and verifying whether an amplitude of the oscillation is larger than an amplitude threshold.

6. The method according to claim 1, wherein a deviation from the expected temperature profile is determined when a measured temperature profile substantially corresponds to a profile of a weld with a defect.

7. The method according to claim 1, wherein the defective condition is related to at least one of the following defects: burn through, porosity, misalignment of the weld, fuse through, unstable welds, deviation of gap between workpieces to be joined or a combination thereof.

8. The method according to claim 1, further comprising:
generating an anomaly signal when a defective condition is positively determined.

9. The method according to claim 8, further comprising:
stopping a welding operation of work pieces when the anomaly signal is generated.

10. The method according to claim 1, further comprising:
adjusting a spot size of the infrared sensor so as to enclose the weld pool.

11. The method according to claim 1, wherein the weld pool temperature is measured every 1-50 ms.

12. The method according to claim 1, wherein the arc welding is applied to at least one of the following joints: a butt joint, a lap joint, a T-joint or a combination thereof.

13. The method according to claim 1, wherein the arc welding is applied to working pieces made from at least one of steel, aluminum or their alloys.

14. A welding system which comprises:
an arc weld torch;
an infrared sensor arranged with the torch, such that the infrared sensor is focused on the weld pool, wherein a measuring pot substantially encompasses the weld pool;
a controller in data communication with the infrared sensor,
wherein the welding system is configured to perform a method for detecting welding defects according to claim 1.

15. The welding system according to claim 14, further comprising a cleaning system for cleaning the infrared sensor.

16. The welding system according to claim 15, wherein the cleaning system comprises a nozzle and a high pressure source to channel fluid towards the infrared sensor.

17. The welding system according to claim 15, wherein the cleaning system comprises a mechanical brush.

18. The welding system according to claim 14, further comprising a casing made from heat resistant material, in which the infrared sensor is fixed.

19. The method according to claim 4, wherein multiple temperature gradient thresholds are defined.

20. The method according to claim 1, wherein the weld pool temperature is measured every 5-15 ms.
